(19) United States
(12) Patent Application Publication
(10) Pub. No.: US 2026/0274302 A1
(43) Pub. Date: Sep. 17, 2026

(54) MONITORING DEVICE, STORAGE MEDIUM STORING COMPUTER PROGRAM FOR MONITORING AND METHOD FOR MONITORING

(71) Applicant: TOYOTA JIDOSHA KABUSHIKI KAISHA, Toyota-shi (JP)

(72) Inventors: Shuntaro SHINOHARA, Tokyo-to (JP); Toshiki MATSUI, Ichikawa-shi (JP); Takahiro FURUKAWA, Nagoya-shi (JP)

(73) Assignee: TOYOTA JIDOSHA KABUSHIKI KAISHA, Toyota-shi (JP)

(21) Appl. No.: 19/362,030

(22) Filed: Oct. 17, 2025

(30) Foreign Application Priority Data
Mar. 12, 2025 (JP) 2025-039683

(51) Int. Cl. B60W 60/00; B60W 30/16; B60W 50/14

(52) U.S. Cl. CPC B60W 60/0015; B60W 30/16; B60W 50/14; B60W 2050/146; B60W 2520/10; B60W 2552/05; B60W 2552/10

(57) ABSTRACT

A monitoring device has a processor configured to decide to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.

### FIELD

The present disclosure relates to a monitoring device, a storage medium storing a computer program for monitoring and a method for monitoring.

### BACKGROUND

A monitoring device is mounted on a vehicle to monitor a state of a driver. For example, the monitoring device monitors whether the driver is looking aside.

The monitoring device of the vehicle monitors the state of the driver even when the vehicle is primarily driven by the automatic control device. This allows the driver to take control of the vehicle when the automatic control device is unable to drive the vehicle safely.

When the driver is looking aside, the monitoring device notifies the driver of a warning to pay attention to driving (for example, refer to Japanese Unexamined Patent Publication No. 2008-217693).

### SUMMARY

However, when the driver is monitored under uniform criterion in any environment, the driver may find the warning annoying.

For example, there are no pedestrians and no intersections or no signals on the expressway. In particular, there is no possibility that another vehicle cuts in ahead of the vehicle from the adjacent lane when two lanes are temporarily restricted to one lane on the expressway.

Thus, it is preferable that an action of the driver other than driving is allowed when the vehicle is traveling on a terrain capable of safely traveling in the automatic control operation.

Accordingly, an object of the present disclosure is to provide a monitoring device which allows a driver to perform an action other than operating a vehicle when the vehicle is traveling on an expressway with a single lane.
(1) According to one embodiment, a monitoring device is provided. The monitoring device has a processor configured to decide to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.
(2) In the monitoring device of embodiment (1), it is preferable that the processor is further configured to decide to mitigate the allowable criterion when the first condition, the second condition, and a third condition in which a front vehicle is located within a second reference range from the current position of the vehicle in the traveling direction are satisfied than when any one of the first condition, the second condition and the third condition is not satisfied.
(3) In the monitoring device of embodiment (1), it is preferable that the processor is further configured to decide to mitigate the allowable criterion when the first condition, the second condition, and a fourth condition in which a speed of the vehicle is equal to or less than a reference speed are satisfied than when any one of the first condition, the second condition, and the fourth condition is not satisfied.
(4) In the monitoring device of embodiment (1), it is preferable that the processor is further configured to decide to mitigate the allowable criterion when the first condition, the second condition and a fifth condition in which a lane closure device indicating that an adjacent lane adjacent to the traveling lane in which the vehicle is traveling is closed is a robust structure are satisfied than when any one of the first condition, the second condition, and the fifth condition is not satisfied.
(5) In any one of the monitoring devices of embodiments (1) to (4), it is preferable that the processor is further configured to decide to set a longer inter-vehicle distance between the vehicle and a front vehicle when the allowable criterion is mitigated than when the allowable criterion is not mitigated.
(6) According to another embodiment, a computer-readable, non-transitory storage medium which stores a computer program for monitoring is provided. The computer program causes a processor to execute a process, and the process includes deciding to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.
(7) According to still another embodiment, a method for monitoring is provided. The method for monitoring is carried out by a monitoring device and includes deciding to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.

Since the monitoring device according to the present disclosure allows a driver to perform an action other than operating a vehicle when the vehicle is traveling on an expressway with a single lane, the driver can perform a second task other than driving.

The object and advantages of the invention will be realized and attained by means of the elements and combinations particularly specified in the claims.

It is to be understood that both the foregoing general description and the following detailed description are exemplary and explanatory, and are not restrictive of the invention, as claimed.

### BRIEF DESCRIPTION OF DRAWINGS

FIG. 1A is a diagram illustrating in overview the operation of a monitoring device of the first embodiment and showing a road on which a vehicle is traveling.

FIG. 1B is a diagram illustrating in overview the operation of the monitoring device of the first embodiment and showing a driver driving the vehicle in the cabin.

FIG. 2 is a hardware configuration diagram of a vehicle in which the monitoring device of the first embodiment is mounted.

FIG. 3 is an example of an operation flow chart for monitoring processing by the monitoring device of the first embodiment.

FIG. 4 is an example of an operation flow chart for decision processing by the monitoring device of the first embodiment.

FIG. 5 is an example of an operation flowchart for lane determination processing by the monitoring device of the first embodiment.

FIG. 6 is a modified example of an operation flowchart for decision processing by the monitoring device of the first embodiment.

FIG. 7 is an example of an operation flow chart for decision processing by the monitoring device of the second embodiment.

FIG. 8 is an example of an operation flow chart for decision processing by the monitoring device of the third embodiment.

FIG. 9 is an example of an operation flow chart for decision processing by the monitoring device of the fourth embodiment.

### DESCRIPTION OF EMBODIMENTS

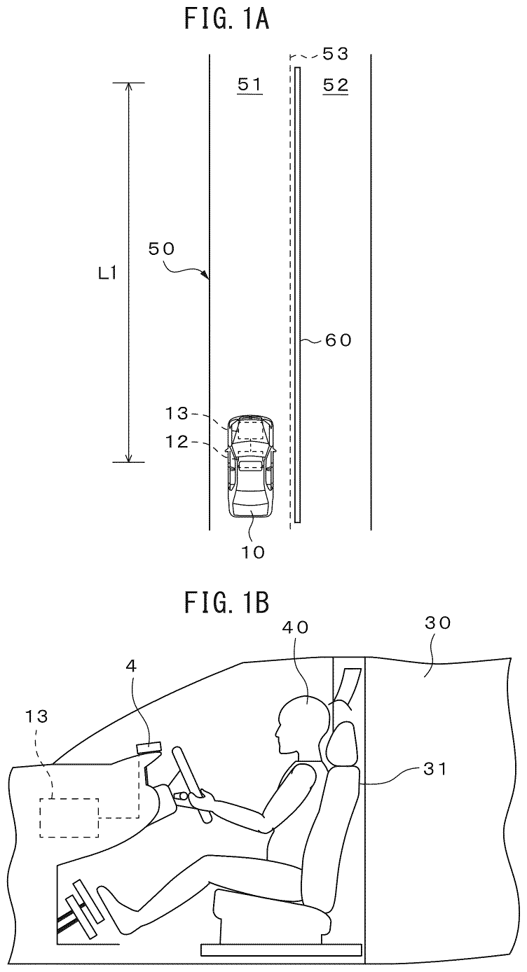

FIG. 1A and FIG. 1B illustrate in overview the operation of a monitoring device of the first embodiment. FIG. 1A is a diagram showing a road 50 on which a vehicle 10 is traveling and FIG. 1B is a diagram showing a driver 40 driving the vehicle 10 in the cabin 30.

As shown in FIG. 1A, the vehicle 10 has an automatic control device 12 and a monitoring device 13. The automatic control device 12 has an automatic driving mode in which the degree to which the driver 40 participates in driving is low (for example, driving mode with levels 2 to 5) and a manual driving mode in which the degree to which the driver 40 participates in driving is high (for example, driving mode with levels 0 to 1). The vehicle 10 may be an autonomous vehicle.

In the manual driving mode, the automatic control device 12 controls the operation of the vehicle 10 based on the operation of the driver 40. The driver 40 sits on the driver's seat 31 so that the driver 40 can operate the steering wheel, brake pedal, and accelerator pedal in the cabin 30.

The vehicle 10 is traveling in the automatic driving mode (e.g., driving mode with level 2). In the automatic driving mode, an action other than driving is allowed for the driver 40. The monitoring device 13 monitors the state of the driver 40 based on the monitoring image representing the driver 40 captured by the monitoring camera 4. The monitoring device 13 determines the state of the driver 40 based on an allowable criterion that allow the driver 40 to perform an action other than operating the vehicle 10.

For example, the allowable criteria is allowable angle of the direction of the line of sight of the driver 40. When the direction of the line of sight exceeds the allowable angle in the left, right, up or down, it is determined that the driver is performing an action other than operating the vehicle.

Even when the vehicle is in the automatic driving mode, the driver 40 is required to take primary control of the vehicle 10 when the automatic control device 12 is unable to safely operate the vehicle. Therefore, the monitoring device 13 notifies a warning to increase the degree to which the driver 40 participates in driving of the vehicle 10 when the state of the driver 40 exceeds the allowable criterion. The allowable criterion may vary depending on the degree to which the driver 40 participates in driving.

The vehicle 10 is traveling on a lane 51 of an expressway 50 having lanes 51, 52. The lane 51 and lane 52 are divided by the lane marking line (lane boundary line) 53. The lane closure devices 60 are disposed along the lane marking line 53 on the lane 52 side, and the lane 52 is closed. The vehicle 10 is traveling on the expressway 50 with a single lane.

A single lane means a lane in the traveling direction of the vehicle 10. Although not shown, the expressway 50 may have an oncoming lane in the direction opposite to the traveling direction of the vehicle 10.

The monitoring device 13 determines that a first condition for mitigating the allowable criterion is satisfied because the vehicle 10 in the automatic driving mode is traveling on the expressway 50 with a single lane.

The monitoring device 13 determines whether there is a point at which another vehicle can enter the lane 51 on which the vehicle 10 is traveling within a first reference range L1 from a current position of the vehicle 10 in the traveling direction based on the map information. An example of the point at which another vehicle can enter the lane 51 is a merging position between the acceleration lane for another vehicle to enter the expressway 50 and the lane 51 at an interchange.

The monitoring device 13 determines that a second condition for mitigating the allowable criterion is satisfied because there is no point at which another vehicle can enter the lane 51 within the first reference range L1 from the current position of the vehicle 10 in the traveling direction.

When the first condition and the second condition are satisfied, it is assumed that the vehicle 10 can safely travel. Thus, the monitoring device 13 decides to mitigate the allowable criterion than when either one of the first condition and the second condition is not satisfied. Not satisfying either one of the first condition and the second condition includes not satisfying both of the first condition and the second condition, and satisfying only one of the first condition and the second condition. For example, mitigating the allowable criterion than when either one of the first condition and the second condition is not satisfied means increasing the allowable angle or stopping monitoring the direction of the line of sight.

This allows the driver 40 to perform an action other than driving than when the allowable criterion is not mitigated. For example, the driver 40 may be allowed to operate an electronic device such as a high performance portable terminal looking more downward than when the allowable criterion is not mitigated.

As described above, the monitoring device 13 of the present embodiment allows the driver 40 to perform an action other than operating the vehicle 10 when the vehicle 10 is traveling on the expressway 50 with the single lane 51, so that the driver 40 can perform a second task other than driving.

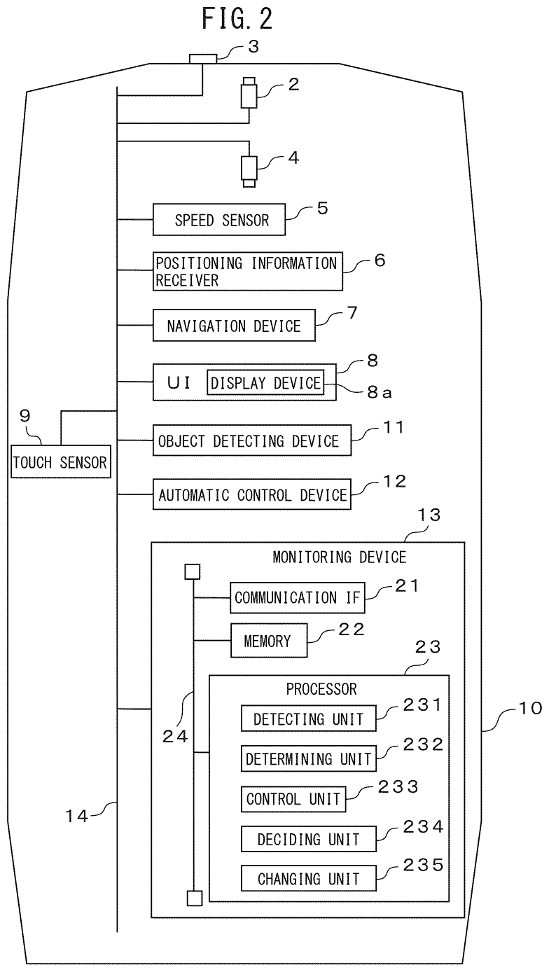

FIG. 2 is a hardware configuration diagram of the vehicle 10 in which the monitoring device 13 of the present embodiment is mounted. The vehicle 10 has a front camera 2, a LiDAR sensor 3, a monitoring camera 4, a speed sensor 5, a positioning information receiver 6, a navigation device 7, a user interface (UI) 8, a touch sensor 9, an object detecting device 11, an automatic control device 12, the monitoring device 13, etc.

The front camera 2, the LiDAR sensor 3, the monitoring camera 4, the speed sensor 5, the positioning information receiver 6, the navigation device 7, the user interface (UI) 8, the touch sensor 9, the object detecting device 11, the automatic control device 12, and the monitoring device 13 are communicatively connected through the in-vehicle network 14 conforming to the standards such as the controller area network.

The front camera 2 is an example of an image capturing unit provided in the vehicle 10. The front camera 2 is mounted to the vehicle 10 so as to face the front of the vehicle 10. The front camera 2 captures a front image in which the environment of a predetermined area in front of the vehicle 10 is represented. The front image may represent a road contained within a predetermined area in front of the vehicle 10 and road features such as lane marking lines on the road surface thereof. The front image represents a lane closure device, etc. which represents a lane is closed. The front camera 2 has a two-dimensional detector composed of arrays of photoelectric conversion elements sensitive to visible light, such as CCD or C-MOS, and an imaging optical system for imaging an image of an area to be captured on a two-dimensional detector. The front image is an example of surrounding environment information representing the environment around the vehicle.

The front camera 2 outputs the front image and the front image acquisition time to the object detecting device 11, etc. through the in-vehicle network 14. The front image is used to detect other objects around the vehicle 10 in the object detecting device 11.

The LiDAR sensor 3 is attached to, for example, the outer surface of the vehicle 10 so as to face the front of the vehicle 10. The LiDAR sensor 3 emits the laser to scan toward a predetermined field of view in front of the vehicle 10 at a reflected wave information acquisition time that is set at a predetermined period and receives the reflection wave reflected by the reflective object.

The time taken for the reflected wave to return has distance information between other objects located in the direction in which the laser is emitted and the vehicle 10. The LiDAR sensor 3 outputs the reflected wave information to the object detecting device 13, etc. through the in-vehicle network 14 together with the reflected wave information acquisition time in which the laser is emitted. The reflected wave information is used to detect other objects around the vehicle 10 in the object detecting device 11. In the present embodiment, the reflected wave information acquisition time is synchronized with the front image acquisition time.
The reflected wave information is an example of surrounding environment information representing the environment around the vehicle.

The monitoring camera 4 is disposed inside the cabin 30 to capture a monitoring image including the face of the driver 40 driving the vehicle 10. The monitoring camera 4 is disposed, for example, on a dashboard. The monitoring camera 4 is an example of an information acquisition unit that acquires information of the driver 40. The monitoring camera 4 captures a monitoring image representing the vicinity of the driver's seat 31. The monitoring image represents the driver 40 seated in the driver's seat 31.

The monitoring camera 4 has a 2D detector composed of an array of photoelectric conversion elements with infrared sensitivity, such as a CCD or C-MOS, and an imaging optical system that forms an image of the captured region on the 2D detector. Each time a monitoring image is captured, the monitoring camera 4 outputs the monitoring image and the image acquisition time at which the monitoring image has been acquired to the monitoring device 13 through the in-vehicle network 14. The monitoring image is used to detect the state of the driver 40 in the monitoring device 13.

The speed sensor 5 generates a speed signal representing the vehicle speed of the vehicle 10 and outputs the speed signal through the in-vehicle network 14 to the automatic control device 12 and the monitoring device 13, etc. As the speed sensor 5, for example, a sensor that detects the rotational speed of the tire of the vehicle 10 may be used. The automatic control device 12 and the monitoring device 13 calculate the speed of the vehicle 10 based on the speed signal.

The positioning information receiver 6 outputs the positioning information representing the current position of the vehicle 10. For example, the positioning information receiver 6 can be a GNSS receiver. The positioning information receiver 6 outputs the positioning information and the positioning information acquisition time to the navigation device 7 and the monitoring device 13, etc. each time the positioning information is acquired in a predetermined reception period.

The navigation device 7 generates a navigation route from the current position of the vehicle 10 to the target position based on the navigation map information, the target position of the vehicle 10 input from the UI 8, and the positioning information representing the current position of the vehicle 10 input from the positioning information receiver 6. The navigation route includes information about positions such as right turn, left turn, merging, branching, etc. The navigation device 7 newly generates the navigation route of the vehicle 10 when the target position is newly set or when the current position of the vehicle 10 is out of the navigation route. Each time the navigation route is generated, the navigation device 7 outputs the navigation route and map information of a predetermined area including the current position of the vehicle 10 to the automatic control device 12 and the monitoring device 13, etc. through the in-vehicle network 14. It is preferable that the map information includes an area equal to or larger than the first reference range L1.

The UI 8 is an exemplary notification unit. The UI 8 is controlled by the automatic control device 12 and monitoring device 13 to notify the driver 40 of the information about the vehicle 10. The UI 8 has a display device 8a such as a liquid crystal display or a touch panel, etc. in order to display information. The UI 8 may also have a sound-output device (not shown) for notifying the driver 40 of the information. The UI 8 has, for example, a touch panel or an operation button as an input device for inputting operation information from the driver 40 to the vehicle 10. The UI 8 outputs the input information to the automatic control device 12 and the monitoring device 13, etc. through the in-vehicle network 14.

The touch sensor 9 is disposed on the rim part of the steering wheel. The touch sensor 9 detects the pressure on the rim part when the steering wheel is gripped by the driver 40 and outputs a touch detection signal to the automatic control device 12 and the monitoring device 13 through the in-vehicle network 14. An electrostatic capacitance sensor, for example, may be used as the touch sensor 9.

The object detecting device 11 detects an object and its type around the vehicle 10 based on the front image. The object includes a road feature, moving object such as a pedestrian and another vehicle moving around the vehicle 10, a lane closure device representing a closed lane, etc.

The object detecting device 11, for example, has a classifier for detecting an object represented in the image by inputting a front image. As the classifier, for example, a deep neural network (DNN) trained in advance so as to detect an object represented in the image from the input image can be used. The object detecting device 11 may use a classifier other than DNN. For example, the object detecting device 11 may use a support vector machine (SVM) that is trained in advance so as to output a confidence degree in which a target to be detected is represented in the window by inputting a feature quantity (for example, Histograms of Oriented Gradients, HOG) calculated from a window set on an image, as the classifier. Alternatively, the object detecting device 11 may detect the object area by performing template matching between the template represented by the object to be detected and the image.

The object detecting device 11 may also detect an object around the vehicle 10 based on the reflected wave information. In addition, the object detecting device 11 may determine the orientation of the object with respect to the vehicle 10 based on the position of the object in the front image, and the distance between the object and the vehicle 10 may be determined based on this orientation and the reflected wave information output by the LiDAR sensor 3. The object detecting device 11 estimates the position of an object, for example, represented in a vehicle coordinate system having an origin within the vehicle 10, based on the current position of the vehicle 10 and the distance and orientation to the object relative to the vehicle 10. As the position of the object, for example, the center of gravity of the area representing the object can be used. The object detecting device 11 outputs object detection information including information indicating the type of the detected object (for example, a pedestrian, another vehicle, a lane marking line, or a lane closure device) and information indicating the position of the detected object to the automatic control device 12 and the monitoring device 13, etc. When a lane closure device is detected, the object detecting device 11 adds the type of the lane closure device in the object detection information. The type of the lane closure device includes a rigid protective fence, a guardrail, a wire rope, a box beam, a pylon, and a rubber pole.

The object detecting device 11 may detect the object based on the reflected wave information without using the front image. In this case, the object detecting device 11 has, for example, a classifier that identifies an object represented in the reflected wave information by inputting the reflected wave information. Thus, the object detecting device 11 estimates the type of the object and the position of the object based on the reflected wave information.

The automatic control device 12 controls operations including the traveling of the vehicle 10. The automatic control device 12 has two modes of operation with different degrees to which the driver 40 participates in driving. The automatic control device 12 controls the operation of the vehicle 10 in accordance with the operation mode.

For example, the automatic control device 12 has the automatic driving mode in which the degree to which the driver 40 participates in driving is low (for example, driving mode with levels 2 to 5) and the manual driving mode in which the degree to which the driver 40 participates in driving is high (for example, driving mode with levels 0 to 1). In the automatic driving mode, the automatic control device 12 primarily drives the vehicle 10. Further, in the manual operation mode, the driver 40 primarily drives the vehicle 10.

In the driving mode in which the degree to which the driver 40 participates in driving is low, all or some of the driving operations necessary for traveling of the vehicle 10 are executed automatically, while in the driving mode in which the degree to which the driver 40 participates in driving is high, the types of driving operations executed automatically are less than in the driving mode in which the degree to which the driver 40 participates in driving is low, or are zero.

The automatic control device 12 outputs the mode information representing the current operation mode to the monitoring device 13 through the in-vehicle network 14. The automatic control device 12 may output the map information of the high-precision map including the current position of the vehicle 10 to the monitoring device 13.

The automatic control device 12 can drive the vehicle 10 in the automatic driving mode in a region where the automatic driving mode is permitted (for example, a region where a high-precision map has been prepared for control of the vehicle 10). In a region where the automatic driving mode is not permitted, the automatic control device 12 controls the vehicle 10 in the manual driving mode. In response to a request from the driver 40, the automatic control device 12 switches from the automatic driving mode to the manual driving mode or from the manual driving mode to the automatic driving mode. The automatic control device 12 also switches from the automatic driving mode to the manual driving mode when it has determined that the vehicle 10 cannot be safely driven in the automatic driving mode.

The monitoring device 13 carries out detection processing, determination processing, control processing, decision processing, and change processing. For this purpose, the monitoring device 13 has a communication interface (IF) 21, a memory 22 and a processor 23. The communication IF 21, the memory 22 and the processor 23 are connected via a signal wire 24. The communication IF 21 has an interface circuit to connect the monitoring device 13 with the in-vehicle network 14.

The memory 22 is an example of a memory unit, and it has a volatile semiconductor memory and a non-volatile semiconductor memory, for example. The memory 22 stores an application computer program and various data to be used for information processing carried out by the processor 23.

All or some of the functions of the monitoring device 13 are functional modules driven by a computer program operating on the processor 23, for example. The processor 23 has a detecting unit 231, a determining unit 232, a control unit 233, a deciding unit 234, and a changing unit 235. Alternatively, the functional module of the processor 23 may be a specialized computing circuit in the processor 23. The processor 23 has one or more CPUs (Central Processing Units) and their peripheral circuits. The processor 23 may also have other computing circuits such as a logical operation unit, numerical calculation unit or graphics processing unit.

The operation of the detecting unit 231 will now be described. The detecting unit 231 detects the state of the driver 40 based on the monitoring image. The state of the driver 40 includes, for example, the orientation of the face, the direction of the line of sight, the degree to which the eyes are open (hereunder also referred to as “degree of eye opening”), the degree to which the mouth is open (hereunder also referred to as “degree of mouth opening”), and the posture.

The detecting unit 231 may detect the orientation of the face of the driver 40 based on the monitoring image. The angle representing the facial orientation is represented as angles in the horizontal direction and vertical direction between the traveling direction of the vehicle 10 and the direction in which the face of the driver 40 is facing. The detecting unit 231 identifies the locations of predetermined parts of the face such as the eye corners, inner eyes or mouth corner points in the captured monitoring image, by inputting the monitoring image into a classifier trained to detect those predetermined parts of the face.

As such a classifier, for example, a deep neural network (DNN) that has been trained in advance to detect the locations of the predetermined parts of the face shown in the monitoring image from the input image can be used. In addition, a machine learning model such as a support vector machine and a random forest, etc. may be used as the classifier.

The detecting unit 231 compares the locations of the predetermined facial aspects detected from the monitoring image against a standard facial three-dimensional model. The face angle in a three-dimensional model in which the location of each facial aspect maximally matches the aspect location detected from the monitor image is detected as the face angle in the monitor image. The detecting unit 231 notifies the orientation of the face of the driver 40 to the determining unit 232.

The detecting unit 231 may detect the direction of the line of sight of the driver 40 based on the monitoring image. The detecting unit 231 determines the position of the center of the pupil and the position of the center of the eyeball based on the positions of the eye corners and the inner eyes, and detects the direction of the line of sight of the driver 40 based on the direction connecting the position of the center of the eyeball and the position of the center of the pupil, and the orientation of the face of the driver 40. The direction of the line of sight of the driver 40 is represented as angles in the horizontal direction and vertical direction between the traveling direction of the vehicle10 and the direction of the line of sight of the driver 40. The detecting unit 231 notifies the determining unit 232 of the direction of the line of sight of the driver 40.

The detecting unit 231 may detect the degree of eye opening based on the monitoring image. The detecting unit 231 has a classifier that has been trained to detect an area of the eye by inputting a monitoring image. The classifier inputs the monitoring image to detect the area of the eye in the monitoring image.

As such a classifier, for example, a deep neural network (DNN) that has been trained in advance to detect the area of the eye shown in the monitoring image from the input image can be used. In addition, a machine learning model such as a support vector machine and a random forest, etc. may be used as the classifier.

The detecting unit 231 calculates the degree of eye opening as the distance between the upper eyelids and lower eyelids of both the left and right eyes in each of the monitoring images. The detecting unit 231 determines the average value for the degree of eye opening based on multiple monitoring images obtained within the most recent fixed time period. The detecting unit 231 determines the average value of the degree of eye opening as the degree of eye opening of the driver 40. The detecting unit 231 notifies the determining unit 232 of the degree of eye opening of the driver 40.

The detecting unit 231 may detect the degree of mouth opening based on the monitoring image. The detecting unit 231 has a classifier that has been trained to detect an area of the mouth by inputting the monitoring image. The classifier inputs the monitoring image to detect the area of the mouth in the monitoring image.

As such a classifier, for example, a deep neural network (DNN) that has been trained to detect the area of the mouth shown in the monitoring image from the input image can be used. In addition, a machine learning model such as a support vector machine and a random forest, etc. may be used as the classifier.

The detecting unit 231 calculates the degree of mouth opening as the distance between the upper lip and lower lip in each of the monitoring images. The detecting unit 231 determines the average value for the degree of mouth opening based on multiple monitoring images obtained within the most recent fixed time period. The detecting unit 231 determines the average value of the degree of mouth opening as the degree of mouth opening of the driver 40. The detecting unit 231 notifies the degree of mouth opening of the driver 40 to the determining unit 232.

The detecting unit 231 detects the posture of the driver 40 based on the monitoring image. The detecting unit 231 has a classifier that has been trained to detect the posture of the driver 40 by inputting a monitoring image. As such a classifier, for example, a deep neural network (DNN) that has been trained to detect the posture of a human shown in the monitoring image from the input image can be used. The posture of the driver 40, for example, has a posture facing the front, a posture facing the side, a stooped posture and a posture facing the rear, with the traveling direction of the vehicle 10 being front. The detecting unit 231 notifies the determining unit 232 of the detected posture of the driver 40.

The object detecting device 11, the automatic control device 12 and the monitoring device 13 are, for example, Electronic Control Units (ECU). In FIG. 2, the object detecting device 11, the automatic control device 12 and the monitoring device 13 are described as separate devices (for example, the Electronic Control Unit: ECU), but all or two of the devices may also be constructed as a single device.

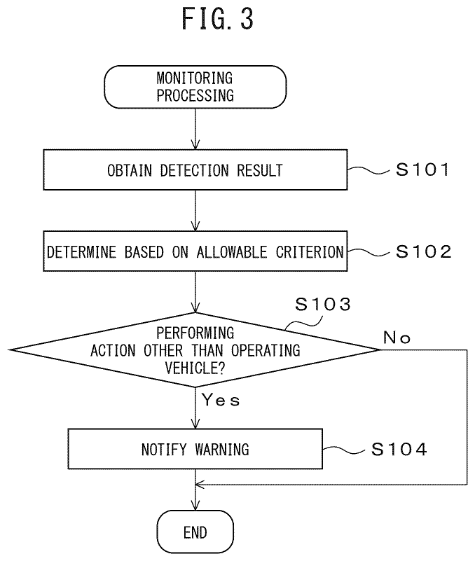

FIG. 3 is an example of an operation flow chart for monitoring processing by the monitoring device 13 of the present embodiment. The monitoring device 13 carries out the monitoring processing according to the operation flow chart shown in FIG. 3, at a monitoring time with a predetermined cycle. The monitoring device 13 may carry out the monitoring processing even when the automatic control device 12 is in either the automatic driving mode or the manual driving mode.

First, the determining unit 232 obtains a detection result representing the state of the driver 40 detected by the detecting unit 231 (step S101). The determining unit 232 may obtain any one of the orientation of the face, the direction of the line of sight, the degree of eye opening, the degree of mouth opening, and the posture detected by the detecting unit 231. The determining unit 232 may obtain the touch detection signal detected by the touch sensor 9.

Next, the determining unit 232 determines the state of the driver 40 based on the allowable criterion that allows the driver 40 to perform an action other than operating the vehicle 10 (step S102). The allowable criterion may be mitigated based on the decision processing described below. In the following description, the default allowable criterion represents the criterion that has not been mitigated.

The default allowable criterion may differ depending on the degree to which the driver 40 participates in driving in the driving mode. The default allowable criterion may be set so that the lower the degree to which the driver 40 participates in driving, the more the criterion is mitigated.

The determining unit 232 determines that the driver 40 is performing an action other than operating the vehicle 10 when the angle representing the orientation of the face of the driver 40 exceeds the allowable criteria in the left or right in the horizontal direction, or up or down in the vertical direction. The allowable criteria represent the allowable angles in the left and right, and up and down directions. The default allowable angles can be, for example, 60 degrees to the left and right, and 30 degrees to the up and down with reference to the traveling direction of the vehicle 10. When the angle representing the orientation of the face of the driver 40 exceeds the allowable angle, the determining unit 232 determines that the driver 40 is performing an action other than operating the vehicle 10. Actions other than operating the vehicle 10 (hereinafter, also referred to as a second task) include operating an electronic device, reading, viewing the scenery outside the window, conversation with an occupant, etc.

When the angle representing the direction of the line of sight of the driver 40 exceeds the allowable criteria in the left or right direction, or in the up or down direction, the determining unit 232 determines that the driver 40 is performing an action other than operating the vehicle 10. The allowable criteria represent the allowable angles in the left and right or up and down direction. The default allowable angles can be, for example, 60 degrees to the left and right, and 30 degrees to the up and down with reference to the traveling direction of the vehicle 10. When the angle representing the direction of the line of sight of the driver 40 exceeds the allowable angle, the determining unit 232 determines that the driver 40 is performing an action other than operating the vehicle 10.

When the degree of eye opening of the driver 40 exceeds the allowable criterion, the determining unit 232 determines that the driver 40 is performing an action other than operating the vehicle 10. The allowable criterion represents the lower limit of eye opening. The default lower limit of eye opening can be, for example, 5 mm. When the degree of eye opening falls below the lower limit of eye opening, the determining unit 232 determines that the driver 40 is performing an action other than operating the vehicle 10.

When the degree of mouth opening of the driver 40 exceeds the allowable criterion, the determining unit 232 determines that the driver 40 is performing an action other than operating the vehicle 10. The allowable criterion represents the upper limit of mouth opening. The default upper limit of mouth opening can be, for example, 15 mm. When the degree of mouth opening exceeds the upper limit of mouth opening, the determining unit 232 determines that the driver 40 is performing an action other than operating the vehicle 10.

When the state in which the steering wheel is not gripped exceeds the allowable criterion, the determining unit 232 determines that the driver 40 is performing an action other than operating the vehicle 10. The allowable criterion represents the upper time limit. The default upper time limit can be, for example, 10 seconds. When the time during which the touch detection signal is not input exceeds the upper limit time, the determining unit 232 determines that the driver 40 is performing an action other than operating the vehicle 10.

The determining unit 232 determines that the driver 40 is performing an action other than operating the vehicle 10, when the state in which the driver 40 is taking a posture facing the side, a stooped posture or a posture facing the rear exceeds the allowable criterion. The allowable criterion represents the upper time limit. The default upper time limit can be, for example, 10 seconds. The determining unit 232 determines that the driver 40 is performing an action other than operating the vehicle 10, when the state in which the driver 40 is taking a posture facing the side, a stooped posture or a posture facing the rear exceeds the upper limit time.

The control unit 232 determines whether it has been determined that the driver 40 is performing an action other than operating the vehicle 10 by the determining unit 232 (step S103).

When it has been determined that the driver 40 is performing an action other than operating the vehicle 10 (step S103-Yes), the control unit 233 notifies the driver 40 via the UI 8 of a warning to increase the degree to which the driver 40 participates in driving of the vehicle 10 (step S104), and the series of processing steps is complete. The control unit 233, for example, displays on the display device 8a to increase the degree to which the driver 40 participates in driving of the vehicle 10.

On the other hand, when it has not been determined that the driver 40 is performing an action other than operating the vehicle 10 (step S103-No), the series of processing steps is complete.

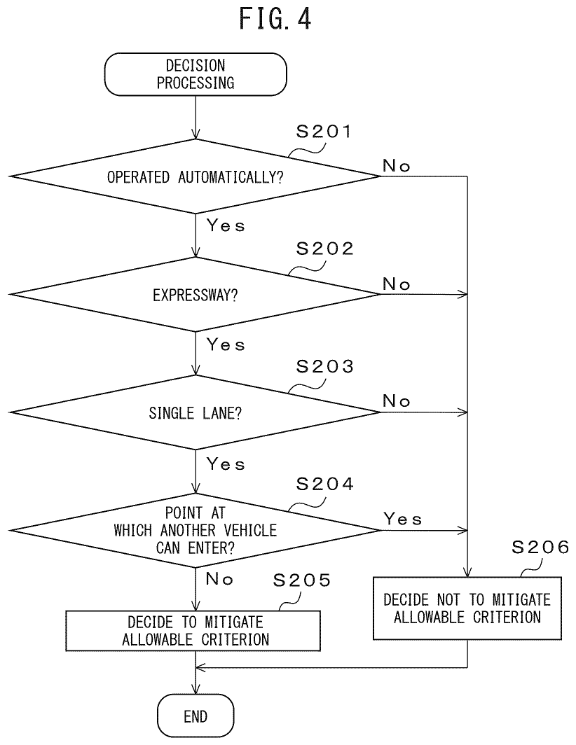

FIG. 4 is an example of an operation flow chart for decision processing by the monitoring device of the monitoring device 13 of the present embodiment. The monitoring device 13 carries out the decision processing according to the operation flow chart shown in FIG. 4, at a decision time with a predetermined cycle. The monitoring device 13 may carry out the decision processing even when the automatic control device 12 is in either the automatic driving mode or the manual driving mode.

First, the deciding unit 234 determines whether the vehicle 10 is operated automatically (step S201). When the mode information representing the automatic driving mode is input from the automatic control device 12, the deciding unit 234 determines that the vehicle 10 is operated automatically. On the other hand, when the mode information representing the manual driving mode is input from the automatic control device 12, the deciding unit 234 determines that the vehicle 10 is not operated automatically. In the automatic driving mode, it may be possible that the allowable criterion can be mitigated because the degree to which the driver 40 participates in driving is low.

When the vehicle 10 is operated automatically (step S201-Yes), the determining unit 232 determines whether the vehicle 10 is traveling on an expressway (step S202). The determining unit 232 determines whether the vehicle 10 is traveling on the expressway based on the current position of the vehicle 10 and the navigation route. It may be possible to mitigate the allowable criterion when the vehicle 10 is traveling on the expressway, because the vehicle 10 is traveling on a terrain without a pedestrian, a signal, and an intersection, etc.

When the vehicle 10 is traveling on the expressway (step S202-Yes), the determining unit 232 determines whether the traveling lane in which the vehicle 10 is traveling is a single lane (step S203). The determining unit 232 may determine whether the traveling lane in which the vehicle 10 is traveling is a single lane based on the map information of the high-precision map including the current position of the vehicle 10. The determining unit 232 may determine whether the traveling lane in which the vehicle 10 is traveling is a single lane by using lane determination processing which will be described later. The fact that the traveling lane in which the vehicle 10 is traveling is a single lane may mitigate the allowable criterion because there is no risk that other vehicles will move in front of the vehicle 10. When the conditions of the steps S201 to S203 are satisfied, it means that the first condition is satisfied.

When the traveling lane in which the vehicle 10 is traveling is a single lane (step S203-Yes), the determining unit 232 determines whether there is any points at which another vehicle can enter the traveling lane of the vehicle 10 within the first reference range L1 from the current position of the vehicle 10 in the traveling direction (step S204). Examples of the points where another vehicle can enter the traveling lane of the vehicle 10 includes a merging position between an acceleration lane for another vehicle to enter the main line and the traveling lane at an interchange or a junction, and a merging position between an acceleration lane for another vehicle to enter the main line and the traveling lane at a service area or a parking area, etc. When the condition of the step S204 is not satisfied, it means that the second condition is satisfied. The fact of no point at which another vehicle can enter the traveling lane of the vehicle 10 may mitigate the allowable criterion because there is no risk that other vehicles will move in front of the vehicle 10. The first reference range L1, for example, can be 2 km to 4 km.

When there is no point at which another vehicle can enter the traveling lane of the vehicle 10 (step S204-No), the deciding unit 234 decides to mitigate the allowable criterion that allows the driver 40 to perform an action other than operating the vehicle 10 than when either one of the first condition and the second condition is not satisfied (step S205), and the series of processing steps is complete. Not satisfying either one of the first condition and the second condition includes not satisfying both of the first condition and the second condition and satisfying only one of the first condition and the second condition.

The changing unit 235 changes the default allowable criterion/criteria to the mitigated allowable criterion/criteria, and notifies the determining unit 232 of the mitigated allowable criterion/criteria. The determining unit 232 monitors the driver 40 based on the mitigated allowable criterion/criteria. Note that if already mitigated allowable criterion/criteria have been used, the changing unit 235 does not change the allowable criterion/criteria. In this case, there is no change in the allowable criterion/criteria used by the determining unit 232.

Mitigating the allowable criterion may involve changing the allowable criterion to an allowable criterion of next higher level of the automatic driving level, for example, changing the allowable criterion to the allowable criterion for the automatic driving level 3 when the vehicle 10 is controlled at the automatic driving level 2.

On the other hand, when the vehicle 10 is not operated automatically (step S201-No), when the vehicle 10 is not traveling on the expressway (step S202-No), when the traveling lane in which the vehicle 10 is traveling is not a single lane (step S203-No), or when there is a point at which another vehicle can enter the traveling lane of the vehicle 10 (step S204-Yes), the deciding unit 234 decides not to mitigate the allowable criterion/criteria (step S206), and the series of processing steps is complete.

When the allowable criterion/criteria have been mitigated, the changing unit 235 changes the allowable criterion/criteria to the default allowable criterion/criteria and notifies the determining unit 232 of the default allowable criterion/criteria. The determining unit 232 monitors the driver 40 based on the default allowable criterion/criteria.

The fact that the vehicle 10 is not operated automatically (step S201-No), that the vehicle 10 is not traveling on an expressway (step S202-No), or that the traveling lane in which the vehicle 10 is traveling is not a single lane (step S203-No) means that the first condition in which the vehicle 10 operated automatically is traveling on an expressway with a single lane is not satisfied. Since not satisfying the first condition means that the vehicle 10 is not operated automatically or the vehicle 10 is not traveling on a safe terrain, the allowable criterion is not mitigated.

In addition, the fact that there is a point at which another vehicle can enter the traveling lane of the vehicle 10 (step S204-Yes) means that the second condition in which there is no point at which another vehicle can enter the traveling lane of the vehicle 10 within the first reference range L1 from the current position of the vehicle 10 in the traveling direction is not satisfied. Since not satisfying the second condition means that the vehicle 10 is not traveling on a safe terrain, the allowable criterion is not mitigated.

The order of the steps S201, S202 and S203 is an example, and the order of these steps may be different. Also, the step S204 may be placed prior to steps S201, S202 and S203.

Next, an example of processing in which the changing unit 235 changes the default allowable criterion to the mitigated allowable criterion will be described below. When the allowable criterion for the orientation of the face of the driver 40 is mitigated, the allowable angle may be changed to 90 degrees to the left and right, and 60 degrees to the up and down, for example, with reference to the traveling direction of the vehicle 10. Mitigating the allowable criterion may also include stopping monitoring the orientation of the face of the driver 40.

When the allowable criterion for the direction of the line of sight of the driver 40 is mitigated, the allowable angle may be changed to 90 degrees to the right and left, and 60 degrees to the up and down, for example, with reference to the traveling direction of the vehicle 10. Mitigating the allowable criterion may also include stopping monitoring the direction of the line of sight of the driver 40.

When the allowable criterion for the degree of eye opening of the driver 40 is mitigated, the lower limit for the degree of eye opening may be changed to, for example, 2 mm. Mitigating the allowable criterion may also include stopping monitoring the degree of eye opening of the driver 40.

When the allowable criterion for the degree of mouth opening of the driver 40 is mitigated, the upper limit for the degree of mouth opening may be changed to, for example, 30 mm. Mitigating the allowable criterion may also include stopping monitoring the degree of mouth opening of the driver 40.

When the allowable criterion for gripping of the steering wheel is mitigated, the upper limit time may be changed to, for example, 30 seconds. Mitigating the allowable criterion may also include stopping monitoring the gripping of the steering wheel.

When the allowable criterion for the posture of the driver 40 is mitigated, the upper limit time may be changed to, for example, 30 seconds. Mitigating the allowable criterion may also include stopping monitoring the posture of the driver 40.

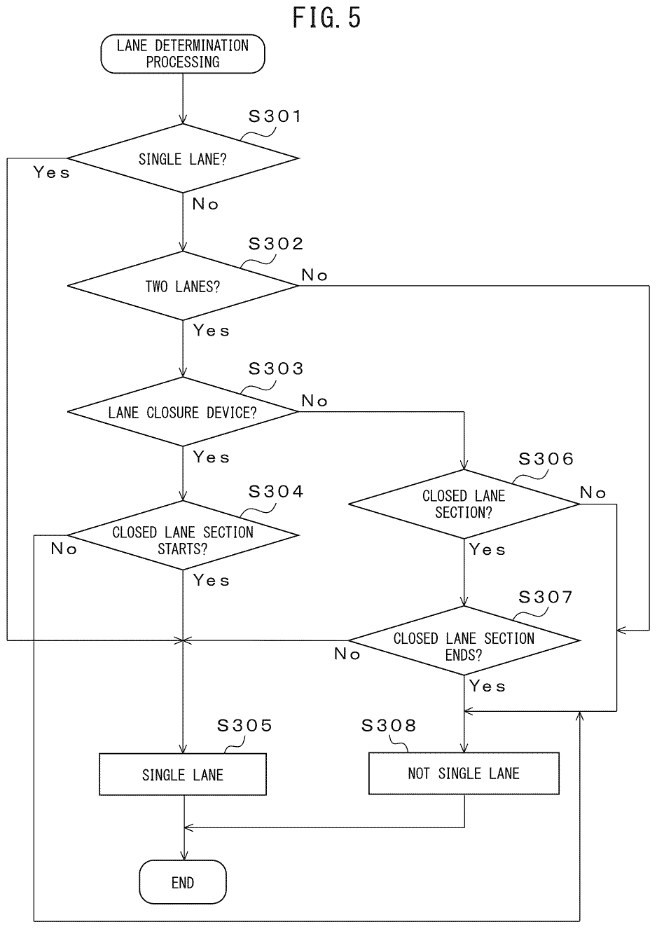

Next, lane determination processing will be described below with reference to FIG. 5. FIG. 5 is an example of an operation flowchart for lane determination processing by the monitoring device 13 of the present embodiment. The lane determination processing may be carried out in the above-described step S203.

First, the determining unit 232 determines whether the vehicle 10 is traveling on a road with a single lane (step S301). The road with a single lane means a road having one lane with respect to the traveling direction of the vehicle 10 (one lane on one side).

The determining unit 232 determines whether the vehicle 10 is traveling on a road with a single lane based on the object detection information input from the object detecting device 11. For example, the determining unit 232 detects the number of lanes located on the vehicle 10 side with respect to the central separation zone based on the object detection information. When there is only one lane, the determining unit 232 determines that the vehicle 10 is traveling on a road with a single lane. When the vehicle 10 is traveling on a road with a single lane (step S301-Yes), the processing proceeds to step S305.

On the other hand, when the vehicle 10 is not traveling on the road with a single lane (step S301-No), the determining unit 232 determines whether the vehicle 10 is traveling on a road with two lanes (step S302). The road with two lanes means a road having two lanes with respect to the traveling direction of the vehicle 10 (a road with two lanes on one side).

The determining unit 232 determines whether the vehicle 10 is traveling on a road with two lanes based on the object detection information input from the object detecting device 11. For example, the determining unit 232 detects the number of lanes located on the vehicle 10 side with respect to the central separation zone based on the object detection information. When there are only two lanes, the determining unit 232 determines that the vehicle 10 is traveling on a road with two lanes. When the vehicle 10 is traveling on a road with three lanes or more, the determining unit 232 determines that the vehicle 10 is not traveling on a road with two lanes.

When the vehicle 10 is traveling on the road with two lanes (step S302-Yes), the determining unit 232 determines whether a lane closure device representing a closed lane is disposed in an adjacent lane (step S303). When the object detection information includes the lane closure device, the determining unit 232 determines whether the projected position of the detected lane closure device onto the road plane is within the adjacent lane. When the lane closure device is located within the adjacent lane, the determining unit 232 determines that the lane closure device is disposed in the adjacent lane.

When the lane closure device is disposed in the adjacent lane (step S303-Yes), the determining unit 232 determines whether a closed lane section in which the lane is closed by the lane closure devices has started (step S304). The determining unit 232 determines that the closed lane section has started in the adjacent lane when a predetermined reference number or more of the lane closure devices have been detected. On the other hand, the determining unit 232 determines that the closed lane section has not started in the adjacent lane when the predetermined reference number or more of the lane closure devices have not been detected.

When the closed lane section in which the lane is closed by the lane closure devices has started (step S304-Yes), the determining unit 232 determines that the traveling lane in which the vehicle 10 is traveling is one lane (step S305), and the series of processing steps is complete. Since the adjacent lane is closed out of the two lanes in the road, the lane in which the vehicle 10 can travel is only the traveling lane.

On the other hand, when the lane closure device is not disposed in the adjacent lane (step S303-No), the determining unit 232 determines whether the closed lane section has been started (step S306). A state in which a closed lane section has been started means a state in which it has been determined that a closed lane section has started in the step S304, and, it has not been determined that the closed lane section has ended in the step S307.

When the closed lane section has been started (step S306-Yes), the determining unit 232 determines whether the closed lane section has ended (step S307). The determining unit 232 determines that the closed lane section has ended when no lane closure devices are detected for a predetermined time or for a predetermined traveling distance in the adjacent lane. On the other hand, the determining unit 232 determines that the closed lane section has not ended when the time or the traveling distance at which no lane closure devices are detected in the adjacent lane does not reach the predetermined time or the predetermined traveling distance.

When the closed lane section has ended (step S307-Yes), when the vehicle 10 is not traveling on a road with two lanes (step S302-No), when the closed lane section has not started (step S304-No), or when the closed lane section has not been started (step S306-No), the determining unit 232 determines that the traveling lane in which the vehicle 10 is traveling is not a single lane (step S308), and the series of processing steps is complete.

As described in detail above, according to the monitoring device of the present embodiment, the monitoring device allows a driver to perform an action other than operating a vehicle when the vehicle is traveling on an expressway with a single lane, and the driver can perform a second task other than driving.

For example, when the allowable criterion is not mitigated even on a terrain where the vehicle can travel safely, the driver may be frequently warned by the monitoring device. Then, the driver may become accustomed to the warning. On the other hand, according to the monitoring device of the present embodiment, since the allowable criterion is mitigated on a terrain where the vehicle can travel safely, the driver is aware that the monitoring level is different depending on the terrain. This allows the driver to immediately accept a warning and increase the degree to which the driver participates in driving when the driver is warned from the monitoring device.

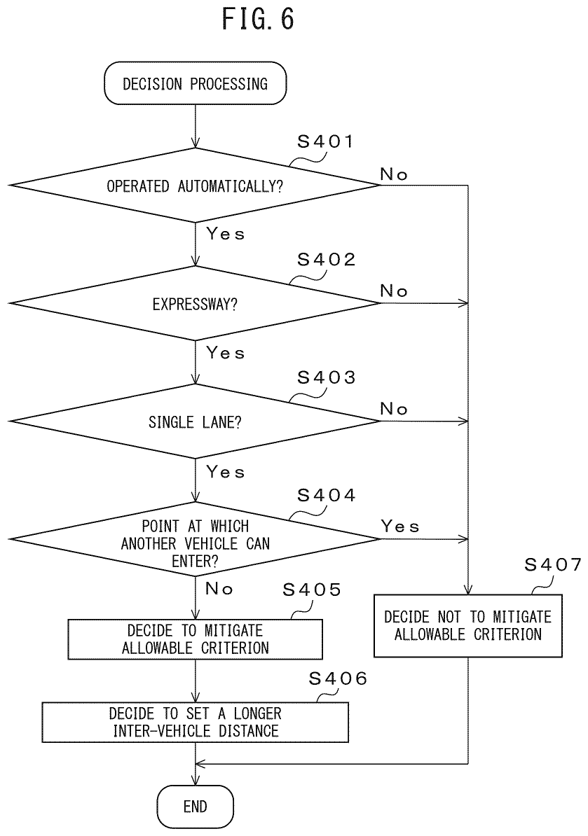

Next, a modified example of the monitoring device 13 of the first embodiment described above will be described below with reference to FIG. 6. FIG. 6 is a modified example of an operation flowchart for decision processing by the monitoring device of the first embodiment.

In the decision processing of this modified example, addition of the step S406 is different from the decision processing shown in FIG. 4 described above. The processing steps S401 to S405 and S407 are similar to the processing steps S201 to S206 described above.

When it has been determined to mitigate the allowable criterion (step S405), the deciding unit 234 decides to set a longer inter-vehicle distance between the vehicle 10 and a front vehicle than when the allowable criterion is not mitigated (step S406), and the series of processing steps is complete.

The changing unit 235 changes the inter-vehicle distance newly so that the distance is longer than when the allowable criterion is not mitigated. The changing unit 235 notifies the automatic control device 12 of the new inter-vehicle distance. The automatic control device 12 controls the vehicle 10 so that the notified inter-vehicle distance is obtained. For example, the new inter-vehicle distance is changed from 10% to 30% longer than the previous inter-vehicle distance.

Since the allowable criterion has been mitigated, the inter-vehicle distance between the vehicle 10 and a front vehicle is set to be a longer distance than when the allowable criterion is not mitigated so that the automatic control device 12 can more safely control the vehicle 10.

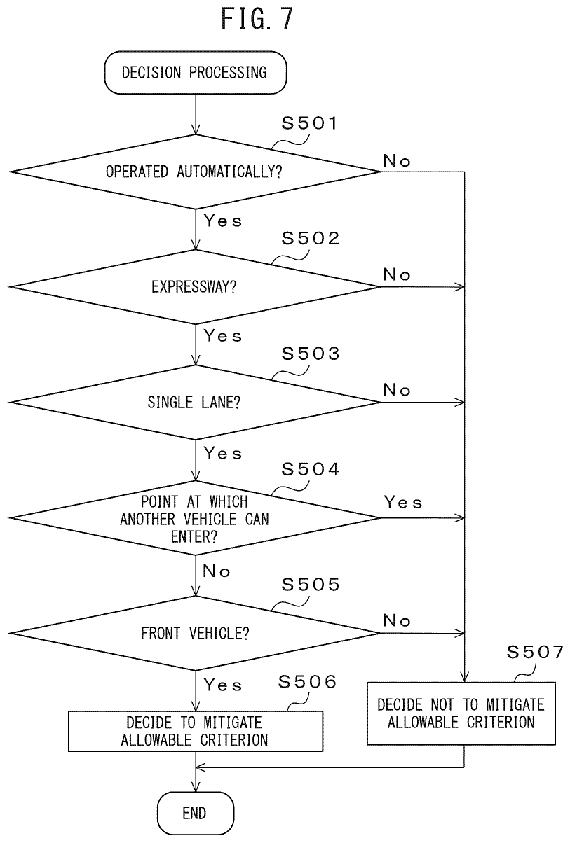

Next, a second embodiment to a fourth embodiment of the monitoring device of the above-described embodiment will be explained below with reference to FIGS. 7 to 9. In the second to fourth embodiments, the description of the first embodiment is applied appropriately for the same processing as in the first embodiment.

FIG. 7 is an example of an operation flow chart for decision processing by the monitoring device 13 of the second embodiment. In the decision processing of the monitoring device 13 of the present embodiment, the addition of the step S505 is different from the decision processing shown in FIG. 4 described above. The processing steps S501 to S504, S506 and S507 are similar to the processing steps S201 to S206 described above.

In the decision processing of the present embodiment, when there is no point at which another vehicle can enter the traveling lane of the vehicle 10 (step S504-No), the determining unit 232 determines whether a front vehicle is located within a second reference range L2 from the current position of the vehicle 10 in the traveling direction based on the object detection information (step S505). As the second reference range L2, for example, can be 50 m to 200 m.

When the front vehicle is traveling in front of the vehicle 10 within the second reference range L2, it is estimated that there is no obstacle on the traveling lane, and therefore, there is a possibility that the allowable criterion can be mitigated. When the condition of the step S505 is satisfied, it means that the third condition is satisfied.

When the front vehicle is located within the second reference range L2 (step S505-Yes), the deciding unit 234 decides to mitigate the allowable criterion allowing the driver 40 to perform an action other than operating the vehicle 10 than when any one of the first condition, the second condition and the third condition is not satisfied (step S506), and the series of processing steps is complete. Since the third condition is satisfied along with the first and second conditions, it is assumed that the vehicle 10 is traveling on a safer terrain. Not satisfying any of the first, second and third conditions includes not satisfying all of the first, second and third conditions, and satisfying only one or two of the first, second and third conditions.

On the other hand, when the front vehicle is not located within the second reference range L2 (step S505-No), the deciding unit 234 decides not to mitigate the allowable criterion (step S507), and the series of processing steps is complete. When the front vehicle is not located within the second reference range L2, the allowable criterion is not mitigated because the traveling lane of the vehicle 10 may not be sufficiently safe.

Note that the step S505 may be prior to step S504. Also, the step S505 may be prior to steps S501, S502 and S503.

According to the monitoring device of the present embodiment described above, the same effect as in the first embodiment explained above is achieved.

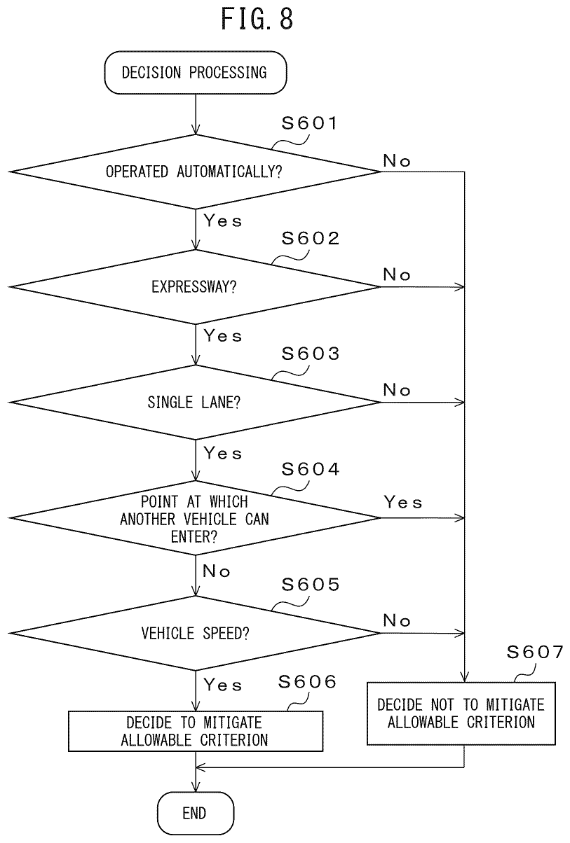

FIG. 8 is an example of an operation flow chart for decision processing by the monitoring device 13 of the third embodiment. In the decision processing of the monitoring device 13 of the present embodiment, the addition of the S605 is different from the decision processing shown in FIG. 4 described above. The processing steps S601 to S604, S606 and S607 are similar to the processing steps S201 to S206 described above.

In the decision processing of the present embodiment, when there is no point at which another vehicle can enter the traveling lane of the vehicle 10 (step S604-No), the determining unit 232 determines whether the speed of the vehicle 10 is equal to or less than the reference speed based on the speed signal (step S605). The reference velocity can be, for example, 100 km/h.

When the speed of the vehicle 10 is equal to or less than the reference speed, the allowable criterion may be mitigated because the vehicle 10 is traveling at a safe speed. When the condition of the step S605 is satisfied, it means that the fourth condition is satisfied.

When the speed of the vehicle 10 is equal to or less than the reference speed (step S605-Yes), the deciding unit 234 decides to mitigate the allowable criterion allowing the driver 40 to perform an action other than operating the vehicle 10 than when any of the first condition, the second condition, and the fourth condition is not satisfied (step S606), and the series of processing steps is complete. Since the fourth condition is satisfied along with the first and second conditions, it is assumed that the vehicle 10 is traveling on a safe terrain at a safe speed. Not satisfying any of the first, second and fourth conditions includes not satisfying all of the first, second and fourth conditions, and satisfying only one or two of the first, second and fourth conditions.

On the other hand, when the speed of the vehicle 10 is not equal to or less than the reference speed (step S605-No), the deciding unit 234 decides not to mitigate the allowable criterion (step S607), and the series of processing steps is complete. When the speed of the vehicle 10 is not equal to or less than the reference speed, the allowable criterion is not mitigated because the speed of the vehicle 10 may not be sufficiently safe.

Note that the step S605 may be placed prior to step S604. Also, the step S605 may be placed prior to steps S601, S602 and S603.

According to the monitoring device of the present embodiment described above, the same effect as the first embodiment explained above is achieved.

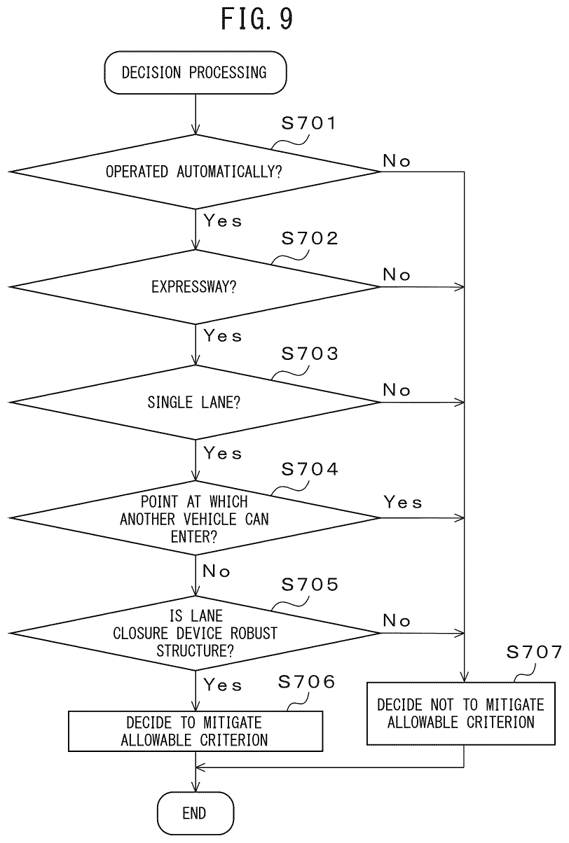

FIG. 9 is an example of an operation flow chart for decision processing by the monitoring device 13 of the fourth embodiment. In the decision processing of the monitoring device 13 of the present embodiment, the addition of step S705 is different from the decision processing shown in FIG. 4 described above. The processing steps S701 to S704, S706 and S707 are similar to the processing steps S201 to S206 described above.

In the decision processing of the present embodiment, when it has been determined that the lane closure device is disposed in the adjacent lane adjacent to the traveling lane in which the vehicle 10 is traveling (refer to the step S303), the determining unit 232 obtains the type of the lane closure device included in the object detection information in in the processing step S703.

In addition, when there is no point at which another vehicle can enter the traveling lane of the vehicle 10 (step S704-No), the determining unit 232 determines whether the lane closure device indicating that the adjacent lane adjacent to the traveling lane in which the vehicle 10 is traveling is closed is a robust structure (step S705). The types of lane closure device that is a robust structure include a rigid protective fence, a guardrail, and a wire rope, etc. The types of lane closure device that is not a robust structure include a box beam, a pylon, and a rubber pole, etc.

When the lane closure device is a robust structure, the allowable criterion may be mitigated because a moving object is unlikely to enter the traveling lane of the vehicle 10 from an adjacent or oncoming lanes. When the condition of the step S705 is satisfied, it means that the fifth condition is satisfied.

When the lane closure device is a robust structure (step S705-Yes), the deciding unit 234 decides to mitigate the allowable criterion allowing the driver 40 to perform an action other than operating the vehicle 10 than when any of the first condition, the second condition and the fifth condition is not satisfied (step S706), and the series of processing steps is complete. Since the fifth condition is satisfied along with the first and second conditions, it is assumed that the vehicle 10 is traveling on a safe terrain. Not satisfying any of the first, second and fifth conditions includes not satisfying all of the first, second and fifth conditions, and satisfying only one or two of the first, second and fifth conditions.

On the other hand, when the lane closure device is not a robust structure (step S705-No), the deciding unit 234 decides not to mitigate the allowable criterion (step S707) and the series of processing steps is complete. When the lane closure device is not a robust structure, the allowable criterion is not mitigated because it is not assumed that the vehicle 10 is traveling on a sufficiently safe terrain.

Note that the step S705 may be placed prior to step S704. Also, the step S705 may be placed prior to steps S701, S702 and S703.

According to the monitoring device of the present embodiment described above, the same effect as in the first embodiment explained above is achieved.

The monitoring device, computer program for monitoring and monitoring method according to the embodiments described in the present disclosure may incorporate appropriate modifications that still fall within the gist of the disclosure. Moreover, the technical scope of the disclosure is not limited to these embodiments, and includes the invention and its equivalents as laid out in the claims.

For example, in the decision processing of the first embodiment, it was determined whether the first condition and the second condition are satisfied. In this decision processing, it may be determined whether the third and fourth conditions, or the third and fifth conditions, or the fourth and fifth conditions, or the third, fourth and fifth conditions are satisfied along with the first and second conditions. The deciding unit may decide to mitigate the allowable criterion when these conditions are satisfied.

1. A monitoring device comprising:
a processor configured to
decide to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.

2. The monitoring device according to claim 1, wherein the processor is further configured to decide to mitigate the allowable criterion when the first condition, the second condition, and a third condition in which a front vehicle is located within a second reference range from the current position of the vehicle in the traveling direction are satisfied than when any one of the first condition, the second condition and the third condition is not satisfied.

3. The monitoring device according to claim 1, wherein the processor is further configured to decide to mitigate the allowable criterion when the first condition, the second condition, and a fourth condition in which a speed of the vehicle is equal to or less than a reference speed are satisfied than when any one of the first condition, the second condition, and the fourth condition is not satisfied.

4. The monitoring device according to claim 1, wherein the processor is further configured to decide to mitigate the allowable criterion when the first condition, the second condition and a fifth condition in which a lane closure device indicating that an adjacent lane adjacent to the traveling lane in which the vehicle is traveling is closed is a robust structure are satisfied than when any one of the first condition, the second condition, and the fifth condition is not satisfied.

5. The monitoring device according to claim 1, wherein the processor is further configured to decide to set a longer inter-vehicle distance between the vehicle and a front vehicle when the allowable criterion is mitigated than when the allowable criterion is not mitigated.

6. A computer-readable, non-transitory storage medium storing a computer program for monitoring, which causes a processor to execute a process, the process comprising:
deciding to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.

7. A method for monitoring carried out by a monitoring device, the method comprising:
deciding to mitigate an allowable criterion that allows a driver to perform an action other than operating a vehicle when a first condition in which a vehicle operated automatically travels on an expressway with a single lane and a second condition in which there is no point at which another vehicle can enter a traveling lane of the vehicle within a first reference range from a current position of the vehicle in a traveling direction are satisfied than when either one of the first condition and the second condition is not satisfied.
